(19) United States
(12) Patent Application Publication
(10) Pub. No.: US 2023/0173370 A1
(43) Pub. Date: Jun. 8, 2023

(54) Golfing Level Assembly

(71) Applicant: Randall Sommers, Emporia, KS (US)

(72) Inventor: Randall Sommers, Emporia, KS (US)

(21) Appl. No.: 17/540,578

(22) Filed: Dec. 2, 2021

(51) Int. Cl. A63B 69/36; A63B 71/06; G01C 9/32; G01C 9/28

(52) U.S. Cl. CPC A63B 69/3608; A63B 71/06; G01C 9/32; G01C 9/28; A63B 2071/0694

(57) ABSTRACT

A golfing level assembly includes a cap that has a brim which extends above a user's line of sight when the user is wearing the cap. A pair of hinges is each disposed on the brim and each of the hinges is positionable in a deployed position or a stored position. A bubble level is coupled to each of the hinges and the bubble level is spaced downwardly from the brim when the hinges are positioned in the deployed position such that the bubble level is positioned within the user's line of sight. The bubble level has a reference line extending along a full length of the bubble level and the reference line is aligned with the visible horizon. In this way the bubble level indicates the degree of slope of the putting green to assist the user with successfully putting on the putting green.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to level devices and more particularly pertains to a new level device for assisting a user with visualizing the slope of a putting green. The device includes a cap that is wearable on the user's head and a bubble level is that pivotally disposed on a brim of the cap. The bubble level includes a reference line that is aligned with the visible horizon thereby facilitating the user to visualize the slope of a putting green.

### (2) Description of Related Art Including Information Disclosed Under 37 CFR 1.97 and 1.98

The prior art relates to level devices including a golf practice device that includes a head band and a rigid rod that extends away from the headband such that a user can visualize the motion of their head relative to a golf club. The prior art discloses a golf ball aligning device that includes a cap and a rigid brim attached to the cap which has a squared edge to facilitate a user to view a possible trajectory of a golf ball. The prior art discloses a golf aiming device that includes a hat and a light emitter coupled to the hat for protecting an alignment mark onto the ground for assisting with aiming a golf shot. The prior art discloses a variety of aiming devices that are attachable to a brim of a hat for assisting with aligning a golf shot.

### BRIEF SUMMARY OF THE INVENTION

An embodiment of the disclosure meets the needs presented above by generally comprising a cap that has a brim which extends above a user's line of sight when the user is wearing the cap. A pair of hinges is each disposed on the brim and each of the hinges is positionable in a deployed position or a stored position. A bubble level is coupled to each of the hinges and the bubble level is spaced downwardly from the brim when the hinges are positioned in the deployed position such that the bubble level is positioned within the user's line of sight. The bubble level has a reference line extending along a full length of the bubble level and the reference line is aligned with the visible horizon. In this way the bubble level indicates the degree of slope of the putting green to assist the user with successfully putting on the putting green.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom perspective view of a golfing level assembly according to an embodiment of the disclosure showing a bubble level positioned in a stored position.

FIG. 2 is a bottom perspective view of an embodiment of the disclosure showing a bubble level positioned in a deployed position.

FIG. 3 is a bottom view of an embodiment of the disclosure.

FIG. 4 is a front view of an embodiment of the disclosure.

FIG. 5 is a right side cut-away view of an embodiment of the disclosure showing a bubble level in a stored position.

FIG. 6 is a right side cut-away view of an embodiment of the disclosure showing a bubble level in a deployed position.

FIG. 7 is a perspective in-use view of an embodiment of the disclosure.

### DETAILED DESCRIPTION OF THE INVENTION

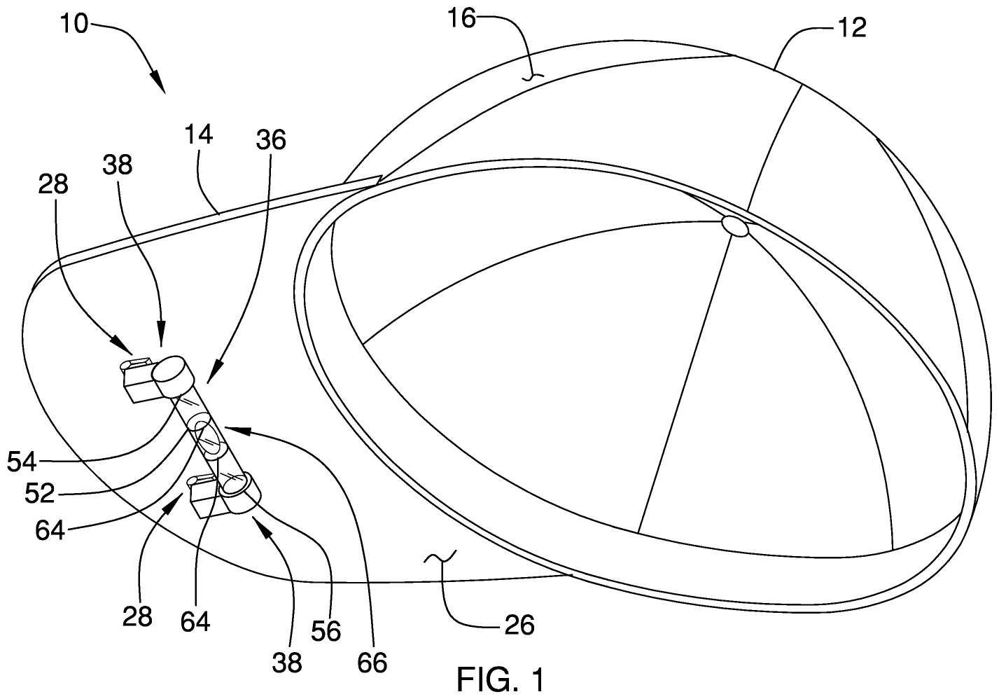

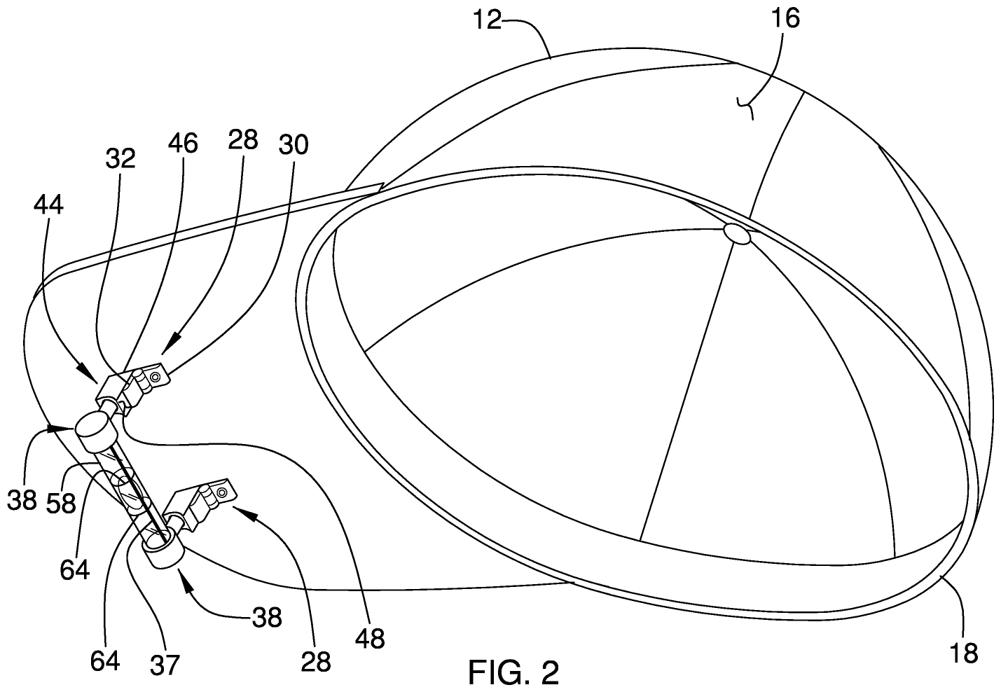

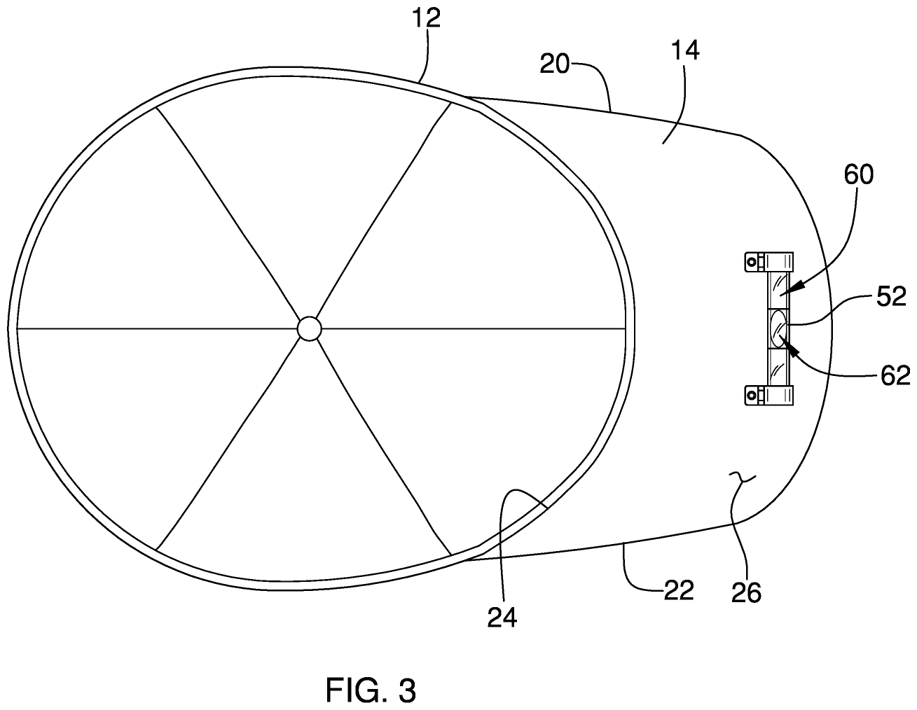

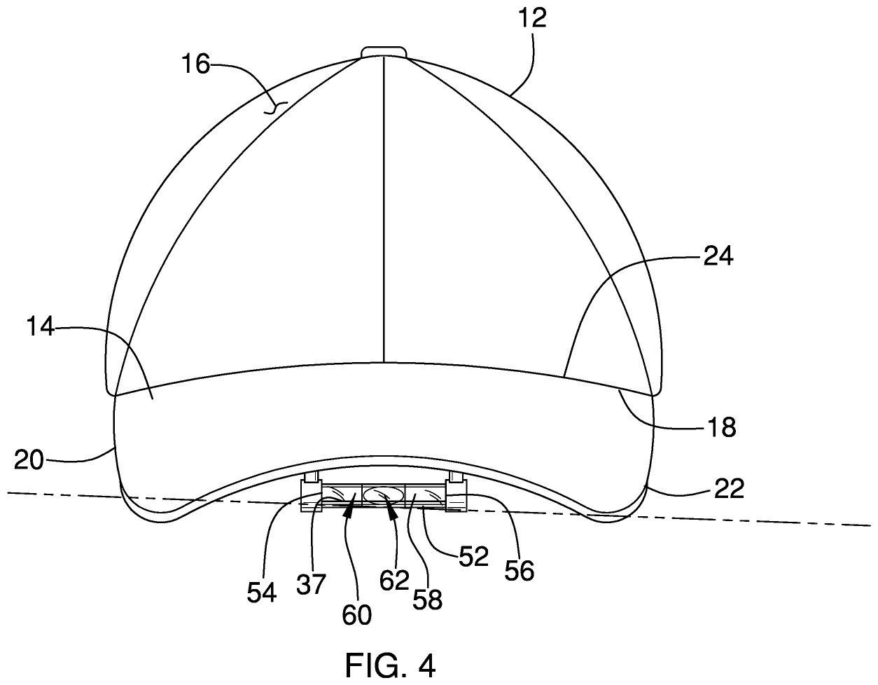

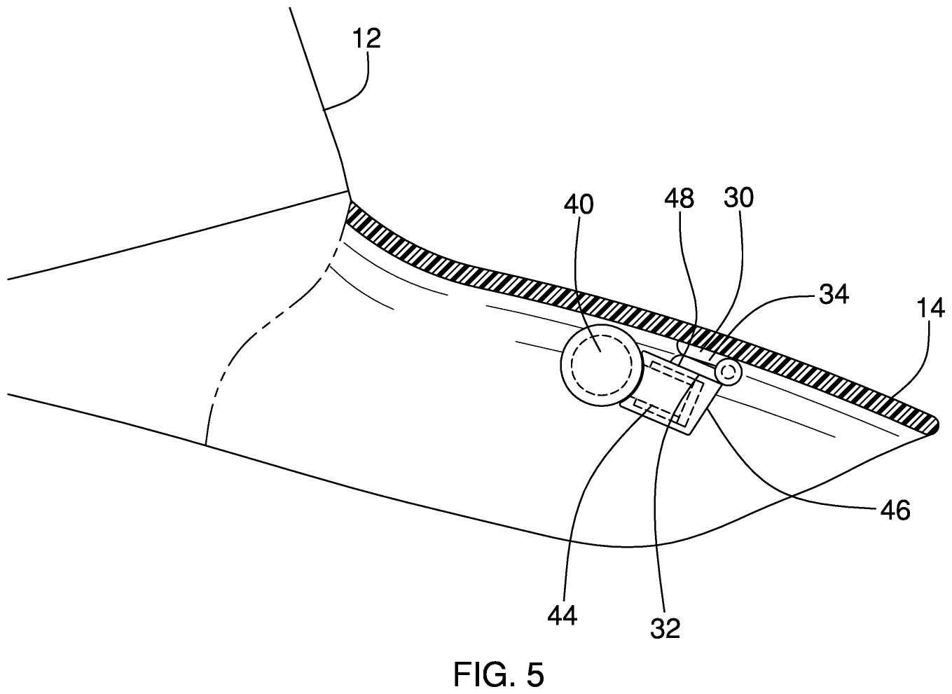

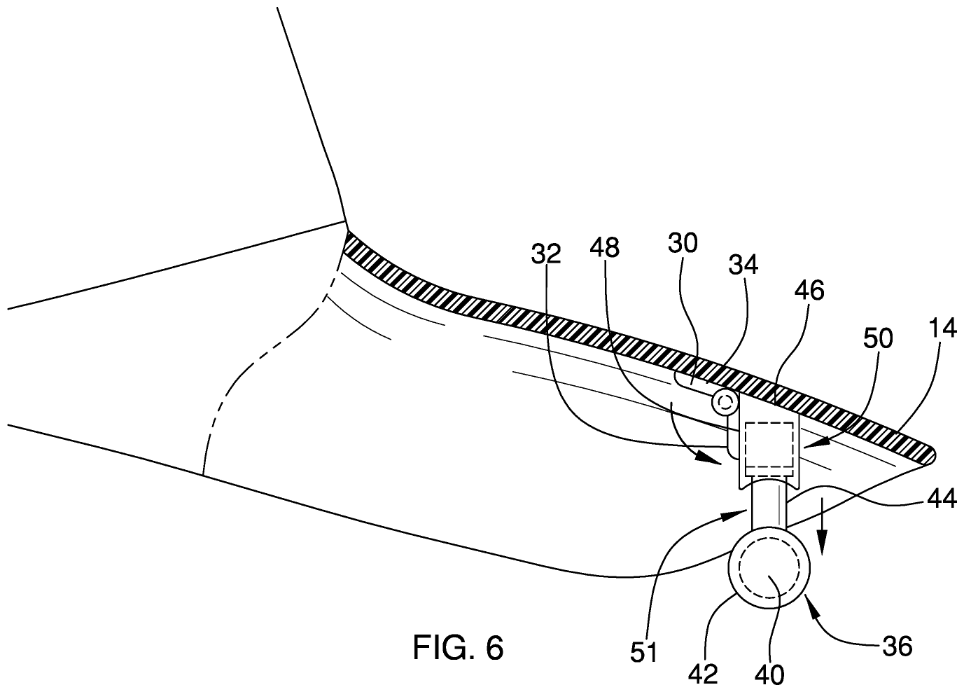

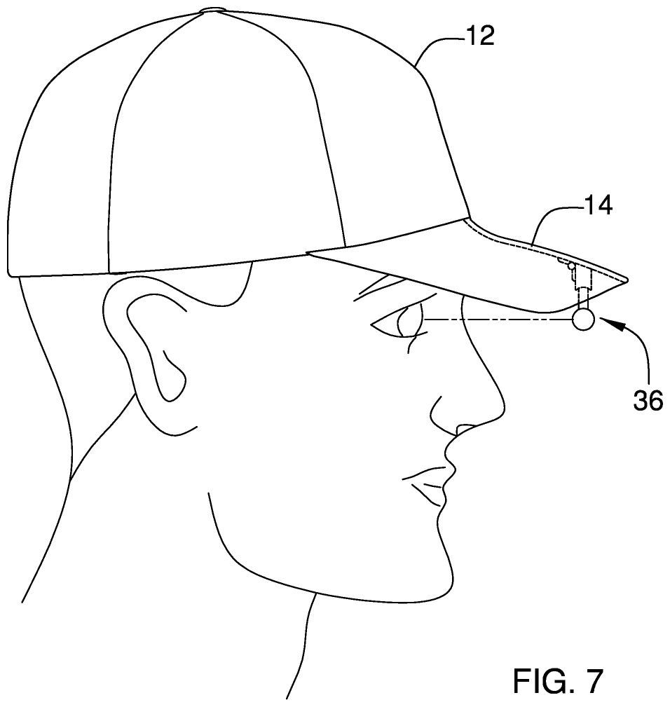

With reference now to the drawings, and in particular to FIGS. 1 through 7 thereof, a new level device embodying the principles and concepts of an embodiment of the disclosure and generally designated by the reference numeral 10 will be described.

As best illustrated in FIGS. 1 through 7, the golfing level assembly 10 generally comprises a cap 12 that has a brim 14 which extends above a user's line of sight when the user is wearing the cap 12. The cap 12 has an outer surface 16 and a lower edge 18, and the brim 14 has a first lateral edge 20, a second lateral edge 22 and a rear edge 24 extending between the first lateral edge 20 and the second lateral edge 22. Additionally, the brim 14 has a bottom surface 26 and the rear edge 24 is coupled to the outer surface 16 of the cap 12 such that the bottom surface 26 is aligned with the lower edge 18 of the cap 12. The cap 12 may be a baseball cap or other type of headwear that might be worn on a golf course.

A pair of hinges 28 is each disposed on the brim 14 and each of the hinges 28 is positionable in a deployed position or a stored position. Each of the hinges 28 comprises a first portion 30 which hingedly engages a second portion 32. The first portion 30 has a coupled surface 34 and the coupled surface 34 of the first portion 30 of each of the hinges 28 is coupled to the bottom surface 26 of the brim 14. Additionally, the hinges 28 are spaced apart from each other and are positioned on a line extending between the first lateral edge 20 and the second lateral edge 22 of the brim 14. The second portion 32 of each of the hinges 28 extends downwardly from the first portion 30 when the hinges 28 are positioned in a deployed position. The second portion 32 of each of the hinges 28 rests against the first portion 30 when the hinges 28 are in a stored position.

A bubble level 36 is coupled to each of the hinges 28 and the bubble level 36 is spaced downwardly from the brim 14 when the hinges 28 are positioned in the deployed position. In this way the bubble level 36 can be positioned within the user's line of sight. The bubble level 36 has a reference line 37 extending along a full length of the bubble level 36. Moreover, the reference line 37 can be aligned with the visible horizon thereby facilitating the bubble level 36 to indicate the degree of slope of the putting green to assist the user with successfully putting on the putting green.

The bubble level 36 comprises a pair of mounts 38 and each of the mounts 38 comprises a cup 40 that has an outer wall 42 and a stem 44 extending away from the outer wall 42. The stem 44 has a distal surface 46 with respect to the outer wall 42 of the cup 40 and a first surface 48 extending between the outer wall 42 of the cup 40 and the distal surface 46. The first surface 48 of the stem 44 of each of the mounts 38 is coupled to the second portion 32 of a respective one of the hinges 28. The distal surface 46 of the stem 44 abuts the bottom surface 26 of the brim 14 having the cup 40 being spaced downwardly from the bottom surface 26 when the hinges 28 are positioned in the deployed position. The cup 40 is positioned adjacent to the bottom surface 26 of the brim 14 when the hinges 28 are position in the stored position. Additionally, the stem 44 comprises a first portion 50 that slidably receives a second portion 51 such that the stem 44 has a telescopically adjustable length.

The bubble level 36 includes a tube 52 that has a first end 54, a second end 56 and an outer wall 58 extending between the first end 54 and the second end 56. Each of the first end 54 and the second end 56 extends into the cup 40 of a respective one of the mounts 38. The tube 52 is comprised of a translucent material to facilitate the user to see through the tube 52. The tube 52 is partially filled with a fluid 60 such that a bubble 62 is defined within the tube 52. The outer wall 42 has a pair of level lines 64 each extending around a full circumference of the outer wall 42. Moreover, each of the level lines 64 is spaced from a center 66 of the tube 52. In this way each of the level lines 64 visually communicates that the tube 52 is oriented level when the bubble 62 is positioned between the level lines 64.

The reference line 37 is printed on the outer wall 42 of the tube 52 and the reference line 37 extends between the first end 54 and the second end 56 of the tube 52. The tube 52 is spaced downwardly from the brim 14 when the first portion 30 of the stem 44 associated with each of the mounts 38 is pulled outwardly from the second portion 32 of the stem 44 associated with each of the mounts 38. In this way the tube 52 is more easily visible for the user when the user is wearing the cap 12. Additionally, the reference line 37 may have a bright color, such as red or orange, thereby enhancing visibility of the reference line 37 for the user.

In use, the cap 12 is worn while the user is playing the game of golf. The bubble level 36 is pivoted downwardly and the first portion 30 of the stem 44 of each of the mounts 38 is drawn downwardly from the second portion 32 of the stem 44 of each of the mounts 38. In this way the bubble level 36 is horizontally oriented within the user's field of vision. Additionally, the user tilts their head, if required, in order to align with reference line 37 with the visible horizon. In this way the user can ascertain the slope of the putting green by observing the positioning of the bubble in the tube 52. Thus, the user can more accurately determine the direction to putt the golf ball in order to successfully sink the golf ball into the hole.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A golfing level assembly for visually determining the slope of a putting green, said assembly comprising:
a cap having a brim wherein said brim is configured to extend above a user's line of sight when the user is wearing said cap;
a pair of hinges, each of said hinges being disposed on said brim, each of said hinges being positionable in a deployed position or a stored position; and
a bubble level being coupled to each of said hinges, said bubble level being spaced downwardly from said brim when said hinges are positioned in said deployed position wherein said bubble level is configured to be positioned within the user's line of sight, said bubble level having a reference line extending along a full length of said bubble level wherein said reference line is configured to be aligned with the visible horizon thereby facilitating said bubble level to indicate the degree of slope of the putting green to assist the user with successfully putting on the putting green.

2. The assembly according to claim 1, wherein:
said cap has an outer surface and a lower edge, said brim having a first lateral edge, a second lateral edge and a rear edge extending between said first lateral edge and said second lateral edge, said brim having a bottom surface, said rear edge being coupled to said outer surface of said cap, said bottom surface being aligned with said lower edge of said cap; and
each of said hinges comprises a first portion hingedly engaging a second portion, said first portion having a coupled surface, said coupled surface of said first portion of each of said hinges being coupled to said bottom surface of said brim, said pair of hinges being spaced apart from each other and being positioned on a line extending between said first lateral edge and said second lateral edge of said brim, said second portion of each of said hinges extending downwardly from said first portion when said hinges are positioned in a deployed position, said second portion of each of said hinges resting against said first portion when said hinges are in a stored position.

3. The assembly according to claim 2, wherein said bubble level comprises a pair of mounts, each of said mounts comprising a cup having an outer wall and a stem extending away from said outer wall, said stem having a distal surface with respect to said outer wall of said cup and a first surface extending between said outer wall of said cup and said distal surface, said first surface of stem of each of said mounts being coupled to said second portion of a respective one of said hinges.

4. The assembly according to claim 3, wherein said distal surface of said stem abuts a bottom surface of said brim having said cup being spaced downwardly from said bottom surface when said hinges are positioned in said deployed position, said cup being positioned adjacent to said bottom surface of said brim when said hinges are position in said stored position.

5. The assembly according to claim 3, wherein said stem comprises a first portion slidably receiving a second portion such that said stem has a telescopically adjustable length.

6. The assembly according to claim 3, wherein said bubble level includes a tube having a first end, a second end and an outer wall extending between said first end and said second end, each of said first end and said second end extending into said cup of a respective one of said mounts, said tube being comprised of a translucent material wherein said tube is configured to facilitate the user to see through said tube.

7. The assembly according to claim 6, wherein said tube is partially filled with a fluid such that a bubble is defined within said tube, said outer wall having a pair of level lines each extending around a full circumference of said outer wall, each of said level lines being spaced from a center of said tube wherein each of said level lines is configured to visually communicate that said tube is oriented level when said bubble is positioned between said level lines.

8. The assembly according to claim 6, wherein said reference line is printed on said outer wall of said tube, said reference line extending between said first end and said second end of said tube.

9. The assembly according to claim 3, wherein:
said stem comprises a first portion slidably receiving a second portion such that said stem has a telescopically adjustable length; and
aid tube is spaced downwardly from said brim when said first portion of said stem associated with each of said mounts is pulled outwardly from said second portion of said stem associated with each of said mounts wherein said tube is configured to be more easily visible for the user.

10. A golfing level assembly for visually determining the slope of a putting green, said assembly comprising:
a cap having a brim wherein said brim is configured to extend above a user's line of sight when the user is wearing said cap, said cap having an outer surface and a lower edge, said brim having a first lateral edge, a second lateral edge and a rear edge extending between said first lateral edge and said second lateral edge, said brim having a bottom surface, said rear edge being coupled to said outer surface of said cap, said bottom surface being aligned with said lower edge of said cap;
a pair of hinges, each of said hinges being disposed on said brim, each of said hinges being positionable in a deployed position or a stored position, each of said hinges comprising a first portion hingedly engaging a second portion, said first portion having a coupled surface, said coupled surface of said first portion of each of said hinges being coupled to said bottom surface of said brim, said pair of hinges being spaced apart from each other and being positioned on a line extending between said first lateral edge and said second lateral edge of said brim, said second portion of each of said hinges extending downwardly from said first portion when said hinges are positioned in a deployed position, said second portion of each of said hinges resting against said first portion when said hinges are in a stored position; and
a bubble level being coupled to each of said hinges, said bubble level being spaced downwardly from said brim when said hinges are positioned in said deployed position wherein said bubble level is configured to be positioned within the user's line of sight, said bubble level having a reference line extending along a full length of said bubble level wherein said reference line is configured to be aligned with the visible horizon thereby facilitating said bubble level to indicate the degree of slope of the putting green to assist the user with successfully putting on the putting green, said bubble level comprising:
a pair of mounts, each of said mounts comprising a cup having an outer wall and a stem extending away from said outer wall, said stem having a distal surface with respect to said outer wall of said cup and a first surface extending between said outer wall of said cup and said distal surface, said first surface of said stem of each of said mounts being coupled to said second portion of a respective one of said hinges, said distal surface of said stem abutting said bottom surface of said brim having said cup being spaced downwardly from said bottom surface when said hinges are positioned in said deployed position, said cup being positioned adjacent to said bottom surface of said brim when said hinges are position in said stored position, said stem comprising a first portion slidably receiving a second portion such that said stem has a telescopically adjustable length; and
a tube having a first end, a second end and an outer wall extending between said first end and said second end, each of said first end and said second end extending into said cup of a respective one of said mounts, said tube being comprised of a translucent material wherein said tube is configured to facilitate the user to see through said tube, said tube being partially filled with a fluid such that a bubble is defined within said tube, said outer wall having a pair of level lines each extending around a full circumference of said outer wall, each of said level lines being spaced from a center of said tube wherein each of said level lines is configured to visually communicate that said tube is oriented level when said bubble is positioned between said level lines, said reference line being printed on said outer wall of said tube, said reference line extending between said first end and said second end of said tube, said tube being spaced downwardly from said brim when said first portion of said stem associated with each of said mounts is pulled outwardly from said second portion of said stem associated with each of said mounts wherein said tube is configured to be more easily visible for the user.
